(19) United States
(12) Patent Application Publication
(10) Pub. No.: US 2026/0120467 A1
(43) Pub. Date: Apr. 30, 2026

(54) SECURITY CAMERA SYSTEM AND METHOD

(71) Applicant: Climax Technology Co., LTD., Taipei (TW)

(72) Inventor: Yi-Kai Chen, Taipei City (TW)

(21) Appl. No.: 18/932,492

(22) Filed: Oct. 30, 2024

(51) Int. Cl. G06V 20/52

(52) U.S. Cl. CPC G06V 20/52; G06V 2201/07

(57) ABSTRACT

A security camera system includes a security camera that captures a scene image of a scene during an installation; a scene analyzer that identifies elements within the scene according to the scene image during the installation, thereby resulting in identified elements; and a risk analyzer that assesses risk levels of intrusion for the identified elements respectively during the installation, thereby determining at least one identified element with risk level higher than a predetermined threshold as an intrusion region. The security camera generates a captured image in a general security operation after the installation, and the scene analyzer then monitors only the intrusion region for detecting intrusion.

### BACKGROUND OF THE INVENTION

### 1. Field of the Invention

The present invention generally relates to a security camera system, and more particularly to a security camera system and method for intrusion detection.

### 2. Description of Related Art

Conventional intruder detection systems for security cameras commonly rely on either manual marking of warning zones or processing the entire camera feed to identify potential intrusions. In the manual marking approach, security personnel or technicians must define specific areas of interest or warning zones within the camera's field of view. This process requires significant labor and expertise, as the personnel must adjust the markings based on the unique layout and installation conditions of each site. This manual method is time-consuming and prone to human error, which can reduce the system's overall efficiency and accuracy.

Alternatively, systems that input the entire screen for global detection often consume excessive computational resources. Since these models must process every frame across the entire field of view, they perform redundant calculations in areas that may not pose any risk, such as areas beyond physical boundaries (e.g., sky or ceiling). This global approach leads to inefficient use of computing power, increasing operational costs and limiting the system's ability to scale effectively, especially in large or complex monitoring environments.

A need has thus arisen to propose a novel scheme to overcome drawbacks of the conventional intruder detection systems by reducing the need for manual labor while improving efficiency and accuracy.

### SUMMARY OF THE INVENTION

In view of the foregoing, it is an object of the embodiment of the present invention to provide a security camera system and method capable of achieving efficient intrusion detection with minimized computational overhead and allowing immediate visual verification.

According to one embodiment, a security camera system includes a security camera, a scene analyzer and a risk analyzer. The security camera captures a scene image of a scene during an installation. The scene analyzer identifies elements within the scene according to the scene image during the installation, thereby resulting in identified elements. The risk analyzer assesses risk levels of intrusion for the identified elements respectively during the installation, thereby determining at least one identified element with risk level higher than a predetermined threshold as an intrusion region. The security camera generates a captured image in a general security operation after the installation, and the scene analyzer then monitors only the intrusion region for detecting intrusion.

### BRIEF DESCRIPTION OF THE DRAWINGS

FIG. 1 shows a block diagram illustrating a security camera system according to one embodiment of the present invention; and

FIG. 2 shows a flow diagram illustrating a security camera method adaptable to the security camera system of FIG. 1.

### DETAILED DESCRIPTION OF THE INVENTION

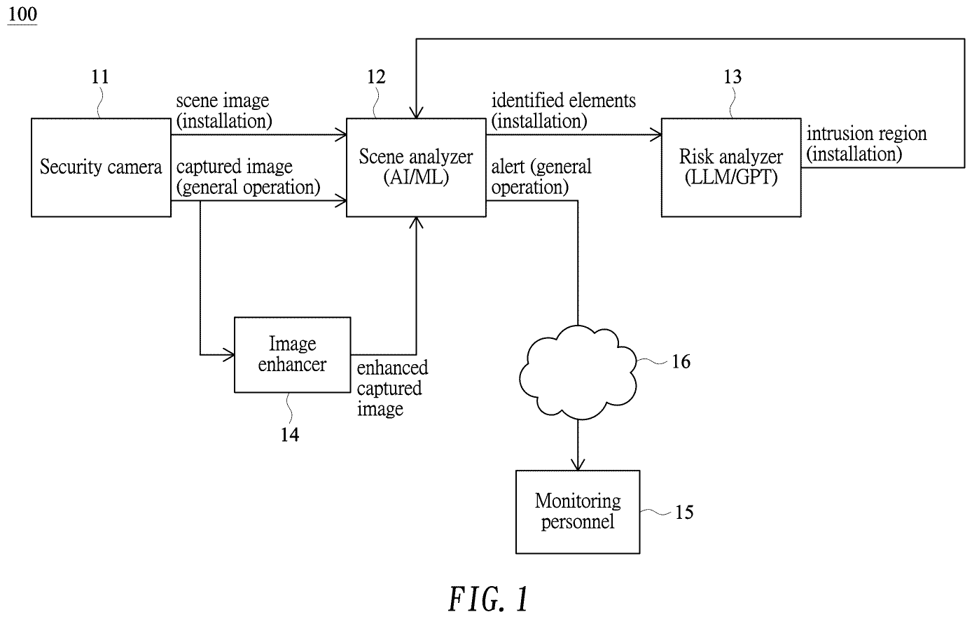

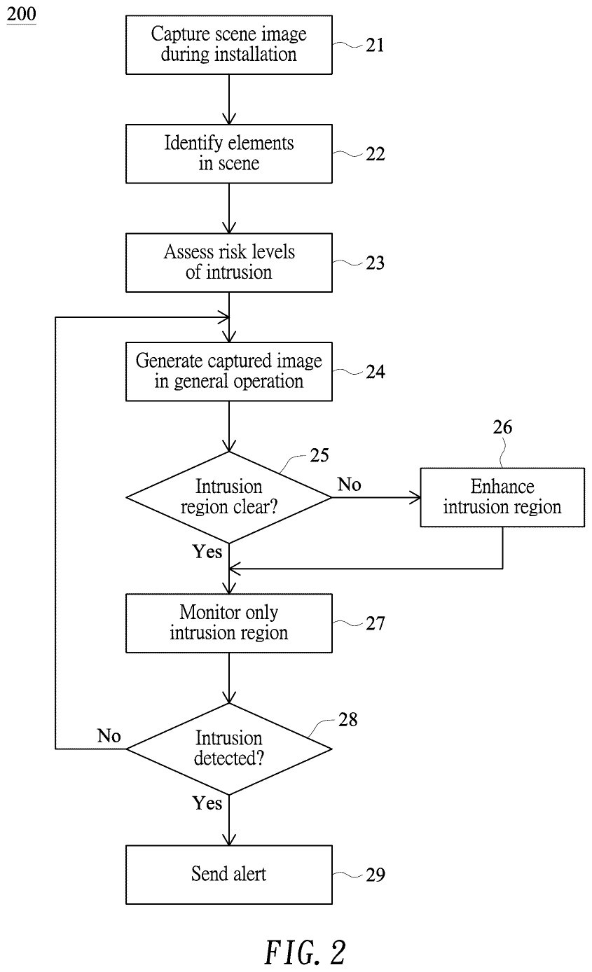

FIG. 1 shows a block diagram illustrating a security camera system 100 according to one embodiment of the present invention, and FIG. 2 shows a flow diagram illustrating a security camera method 200 adaptable to the security camera system 100 of FIG. 1.

In the embodiment, the security camera system (“system” hereinafter) 100 may include a security camera 11, for example, a complementary metal-oxide-semiconductor (CMOS) image sensor, configured to capture (at least) a scene image of a scene (e.g., an indoor or outdoor space) during an installation (or setup) or at an initial stage of operation (step 21).

The system 100 of the embodiment may include a scene analyzer 12 coupled to receive the scene image (from the security camera 11) and configured to identify elements (or features or objects) (e.g., doors and windows in the indoor space or gates, fences, walkways and driveways in the outdoor space) within the scene according to the scene image (step 22) during the installation. The identified elements may be annotated as potential points of interest.

In the embodiment, the scene analyzer 12 may adopt artificial intelligence (AI) and machine learning (ML) to analyze the scene image. Therefore, the scene analyzer 12 may be called AI/ML processing unit or module in the embodiment. Conventional AI/ML techniques for analyzing an image may be adopted, details of which are thus omitted for brevity. The AI/ML model of the AI/ML processing unit is pre-trained with a large dataset to recognize various environmental elements accurately and efficiently. The AI/ML processing unit may include a graphics processing unit (GPU) required for high-performance processing of the AI/ML models, such as image recognition and object detection.

The system 100 of the embodiment may include a risk analyzer 13 coupled to receive the scene image with the identified elements (from the scene analyzer 12) and configured to assess risk levels of intrusion for the identified elements respectively (step 23) during the installation, thereby determining at least one identified element with risk level higher than a predetermined threshold as a (likely) intrusion region, which may be marked. An identified element with higher risk level of intrusion is more likely to be targeted by intruders and is assessed based on corresponding location and context within the scene. For example, the risk analyzer 13 may recognize a door with higher risk level compared to a window based on its proximity to other objects or paths.

In one exemplary embodiment, a main entrance door and windows in the indoor space are assessed with higher risk levels as likely intrusion regions. In another exemplary embodiment, gates and fences in the outdoor space are assessed with higher risk levels as likely intrusion regions.

In the embodiment, the risk analyzer 13 may adopt large language model (LLM) and generative pre-trained transformer (GPT) to assess risk levels of intrusion for the identified elements. Therefore, the risk analyzer 13 may be called LLM/GPT processing unit or module in the embodiment. Conventional LLM/GPT techniques for analyzing an image may be adopted, details of which are thus omitted for brevity. The LLM/GPT processing unit performs contextual and predictive analysis to add a layer of intelligence by analyzing the identified elements and understanding scene context. For example, the LLM/GPT processing unit evaluates which identified elements (such as doors or gates) are most likely to be intrusion regions based on the scene and surrounding elements. By using its extensive language and pattern recognition capabilities, the LLM/GPT processing unit can predict which identified elements have higher risk of intrusion. The LLM/GPT processing unit integrates knowledge from various sources and scenarios to make informed predictions, thereby enhancing the AL/ML model's initial recognition. The LLM/GPT processing unit may include a high-performance central processing unit (CPU), required for running the LLM/GPT models, which may involve substantial computational tasks.

After the installation, the system 100 enters a general security operation, in which the security camera 11 may generate (at least) a captured image (step 24). Step 25 is optionally performed to determine whether the (marked) intrusion region on the captured image is clear enough. If the intrusion region on the captured image is not clear enough, the flow goes to step 26 to enhance the intrusion region followed by going to step 27, otherwise the flow goes directly to step 27. Whether the intrusion region on the captured image is clear may be determined by comparing the captured image with a reference (clear) image. Clarity of the captured image may be affected, for example, by improper focus, motion blur during exposure or insufficient lighting.

The system 100 may include an image enhancer 14 configured to (locally) enhance (i.e., improve clarity and quality of) the intrusion region on the captured image (step 26) by techniques such as upscaling, resolution enhancement or high dynamic range (HDR), thereby generating an enhanced captured image. The upscaling techniques digitally enlarge the intrusion region, improving clarity and visibility. HDR techniques increase visibility of areas in high contrast or low-light conditions. Image enhancement (step 26) of the image enhancer 14 may be performed, for example, by an image signal processor (ISP).

In step 27, the scene analyzer 12 is coupled to receive the captured image (from the security camera 11) or the enhanced captured image (from the image enhancer 14) and is configured to monitor only the (marked) intrusion region for detecting (likely) intrusion such as unusual movements or objects within the intrusion region. By narrowing down focus to only the intrusion region, the system 100 can achieve efficient intrusion detection with minimized computational overhead.

Upon detecting potential intrusions (step 28), the scene analyzer 12 may send a real-time alert (step 29) to monitoring personnel 15 (such as a user or central monitoring station), for example, via networking 16 such as the Internet. The alert may include a captured image (or an enhanced captured image) with (at least) a marked intrusion region where intrusion is detected, thereby allowing immediate visual verification.

The system 100 of the embodiment is capable of continuously learning from interaction and confirmations of detected intrusions. For example, if a user confirms an intrusion, the confirmation is fed back to the scene analyzer 12 to refine the model, ensuring that future detections are more accurate. Therefore, the system 100 can adapt to changes in the environment, such as new objects appearing or rearrangements, thereby maintaining effective monitoring over time.

Although specific embodiments have been illustrated and described, it will be appreciated by those skilled in the art that various modifications may be made without departing from the scope of the present invention, which is intended to be limited solely by the appended claims.

1. A security camera system, comprising:
a security camera that captures a scene image of a scene during an installation;
a scene analyzer that identifies elements within the scene according to the scene image during the installation, thereby resulting in identified elements; and
a risk analyzer that assesses risk levels of intrusion for the identified elements respectively during the installation, thereby determining at least one identified element with risk level higher than a predetermined threshold as an intrusion region;
wherein the security camera generates a captured image in a general security operation after the installation, and the scene analyzer then monitors only the intrusion region for detecting intrusion.

2. The system of claim 1, wherein the scene analyzer adopts artificial intelligence (AI) and machine learning (ML) to identify the identified elements.

3. The system of claim 1, wherein the risk analyzer adopts large language model (LLM) and generative pre-trained transformer (GPT) to assess risk levels of intrusion for the identified elements.

4. The system of claim 1, further comprising:
an image enhancer that enhances the intrusion region on the captured image, thereby generating an enhanced captured image, which is fed to the scene analyzer to monitor only the intrusion region for detecting intrusion.

5. The system of claim 1, wherein the scene analyzer sends an alert to monitoring personnel for visual verification upon detecting intrusion.

6. The system of claim 5, wherein the alert comprises a captured image with a marked intrusion region where intrusion is detected.

7. A security camera method, comprising:
capturing a scene image of a scene during an installation;
identifying elements within the scene according to the scene image during the installation, thereby resulting in identified elements;
assessing risk levels of intrusion for the identified elements respectively during the installation, thereby determining at least one identified element with risk level higher than a predetermined threshold as an intrusion region;
generating a captured image in a general security operation after the installation; and
monitoring only the intrusion region for detecting intrusion.

8. The method of claim 7, wherein the step of identifying elements within the scene adopts artificial intelligence (AI) and machine learning (ML) to identify the identified elements.

9. The method of claim 7, wherein the step of assessing risk levels of intrusion adopts large language model (LLM) and generative pre-trained transformer (GPT) to assess risk levels of intrusion for the identified elements.

10. The method of claim 7, further comprising:
enhancing the intrusion region on the captured image, thereby generating an enhanced captured image, which is used to monitor only the intrusion region for detecting intrusion.

11. The method of claim 7, further comprising:
sending an alert to monitoring personnel for visual verification upon detecting intrusion.

12. The method of claim 11, wherein the alert comprises a captured image with a marked intrusion region where intrusion is detected.
